(19) United States
(12) Patent Application Publication
(10) Pub. No.: US 2007/0177502 A1
(43) Pub. Date: Aug. 2, 2007

(54) Communication system, communication apparatus, congestion control method used therefor, and program for the method

(75) Inventor: Takayuki Hama, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/638,517

(22) Filed: Dec. 14, 2006

(30) Foreign Application Priority Data
Feb. 1, 2006 (JP) 2006-024013

(51) Int. Cl. H04L 12/26

(52) U.S. Cl. 370/229

(57) ABSTRACT

There is provided a communication apparatus capable of increasing throughput even when the loss rate is high, without special congestion information being notified from a network. A congestion determination section determines whether the current state is light/heavy congestion from ACK packets and the content stored in a session state storage section, and hands the processing to a network state estimation section or a normal transfer section according to the result of the determination. The network state estimation section estimates the network congestion state from ACK packets and the content stored in the session state storage section. A light/heavy congestion determination section determines whether the state is light congestion or heavy congestion from the result of the estimation by the network state estimation section, and hands the processing to a resending determination section or a heavy congestion resending section according to the result of the determination. The resending determination section determines whether there is any unresent segment among segments requested by an ACK from the receiving side to be resent, and hands the processing to a light congestion resending section or the normal transfer section according to the result of the determination.

### BACKGROUND OF THE INVENTION

1. Field of the Invention

The present invention relates to a communication system, a communication apparatus, a congestion control method used therefor, and a program for the method, and in particular to a technique for session control at a protocol layer having a congestion control function in a communication system performing packet exchange.

2. Description of the Prior Art

In packet exchange, some protocols that set a session have both functions of performing flow control for controlling the rate of the sending side so as that it does not exceed the receiving processing capacity of the receiving side and performing congestion control for controlling the rate of the sending side so that network congestion is not caused (hereinafter, both of the functions are collectively referred to as rate control).

In general, this rate control function is often realized at the transport layer of the OSI (open system interconnection) reference model. The rate control method includes a window-control-type method. The window-control-type method is a method for adjusting the number of packets staying at a network per RTT (round trip time). TCP which is widely used in the Internet now is a window-control-type transport layer protocol, and it also has the congestion control function.

In TCP, congestion control is performed by the sending side. Based on an ACK (acknowledgement) packet, the congestion control state is transitioned so that the number of packets to be transmitted is increased. Or, packet loss is detected, the number of packets to be transmitted is decreased, and the packet is resent. The number of packets to be transmitted is determined by a CWND (congestion window), which is the number of packets that can be transmitted per RTT, and the sending side can send data corresponding to the CWND to a receiving side based on the maximum value of sequence numbers (ACK numbers) notified by ACK packets.

If the sequence number in an ACK packet from the receiving side increases, the sending side increases the CWND to increase the number of packets to be transmitted. The amount of increase of the CWND changes in association with the relation between the CWND and an SSTHRESH (slow start threshold). If CWND≦SSTHRESH (slow start phase) is satisfied, then the amount of increase of the CWND corresponds to one packet for one ACK. If CWND>SSTHRESH (congestion avoidance phase) is satisfied, the amount of increase of the CWND corresponds to 1/CWND packet for one ACK.

On the other hand, if packet loss is detected by the receiving side, [the largest sequence number among packets consecutively received]+1 (that is, the smallest value among the sequence numbers for which packet loss has been detected) is notified to the sending side by an ACK packet. On the receiving side, if the sequence number in the ACK packet (the ACK number) overlaps (an overlapping ACK), it is determined that a segment (a section of data) beginning from the ACK number has been lost and resends the lost segment. This is called high-speed resending.

In this case, SSTHRESH=CWND/2 and CWND=SSTHRESH+3*[segment size] are satisfied. Each time a different overlapping ACK arrives, the CWND is increased by the segment size. When transfer of a new packet is permitted based on the CWND value, the new packet is sent. When ACK's for all the sent data return, CWND=SSTHRESH is set. The process to this stage after the high-speed resending is called high-speed recovery. The throughput during the high-speed recovery is half or below the throughput immediately before the loss. After that, the congestion avoidance phase is entered.

When an ACK is not returned for a predetermined time also, it is determined that packet loss has been caused (time out), and the CWND is set to one packet to resend the lost packet. The congestion control is described in Non-Patent Document 1 (“TCP/IP Illustrated: The Protocols” by W. Richard Stevens; Addison-Wesley; 1994).

A SACK (selective ACK) option is specified as a TCP option so that packet resending is quickly performed (see Non-Patent Document 2 (“RFC 2018—TCP Selective Acknowledgement Options” by M. Mathis, J. Mahdavi, S. Floyd and A. Romanow; IETF; 1996), for example). This option is for adding, to an ACK packet, information for notifying consecutive sections among non-consecutive sections caused by packet loss from the receiving side to the sending side. The SACK option is capable of notifying consecutive sections with multiple blocks at a time, and the latest sequence number is stored in the first block. Therefore, the sending side is notified of the largest sequence number that has arrived at the receiving side (the largest received sequence number on the receiving side).

The sending side calculates non-consecutive sections from the notified consecutive sections and resends segments corresponding to the non-consecutive sections. The sending side only has to resend the non-consecutive sections, and therefore the resending efficiency is good. Whether the non-consecutive sections could be resent can be determined from whether the ACK number exceeds the sequence numbers of the non-consecutive sections. If the non-consecutive sections could be resent, information about the consecutive sections before the non-consecutive sections is discarded.

Even if this SACK option is used, the existing congestion control is similar to that by the prior-art method described above. That is, the operation of, if an overlapping ACK is detected, performing packet resending and reducing the CWND to half is performed. This SACK option is widely implemented now and can be said to form a part of standard TCP.

One of conventional TCP problems is that, since the CWND is reduced to half and the throughput is reduced even in the case of loss of only one packet, an empty band of a network cannot be used if random loss occurs. A second problem is that, in the case where packet loss occurs at a high frequency, the congestion avoidance phase is not entered, and high-speed resending and high-speed recovery are repeated, and therefore the throughput is not increased.

In order to cope with the first conventional TCP problem described above, there is a data transfer control method which includes a procedure in which the receiving side calculates the checksum of a received packet, and notifies the sending side that random loss has occurred if the checksum does not correspond, and the sending side does not perform flow control for congestion avoidance if it is notified that the random error has occurred (see Patent Document 1: Japanese Patent No. 3527111, for example).

This method requires both of the sending and receiving sides to change the implementation of TCP. Furthermore, in the case where packet loss occurs at a high frequency, the congestion avoidance phase is not entered, and a state of waiting for an ACK corresponding to a resent random packet repeatedly occurs. As a result, the throughput does not increase, and the second conventional TCP problem is not solved.

Furthermore, this method also has a problem that, when a random loss packet is resent, it is not possible to newly transmit a packet during 1 RTT until after an ACK for the resent random loss packet is returned, and the throughput is decreased during this time. In connection with this problem, fluctuation of the largest ACK number received by the sending side and the maximum transmittable sequence number will be described with the use of FIG. 12.

To simplify the description, the maximum transmittable sequence number is assumed to be equal to [the receiving-side largest ACK number]+CWND, and the receiving-side buffer is assumed to be sufficiently large. It is assumed that the sending side sends data corresponding to the sequence numbers up to the maximum transmittable sequence number to the receiving side during the congestion avoidance phase before time A.

It is assumed that random loss of a packet with the sequence number x is detected by the sending side at the time A, and that packets other than this packet have not been lost. In this case, the sending side performs the operation of resending the packet with the sequence number x without decreasing the CWND. After that, the ACK number sent by the receiving side does not increase (an overlapping ACK) till the time B (=time A+1 RTT) when an ACK corresponding to the resent packet is returned. Therefore, the maximum transmittable sequence number remains x+CWND and does not change.

Therefore, the sending side cannot transmit a packet with a new sequence number to the receiving side during this section. At the time B, the sequence number of the ACK corresponding to the resent packet with the sequence number x becomes x+CWND, and the maximum transmittable sequence number becomes x+2CWND. Therefore, at this time, it is possible to send data corresponding to the CWND, and burst communication is performed.

As another technique, there is a band control method which includes a procedure in which, when packet loss is detected, the CWND is not immediately reduced but is kept as it is, and the CWND is reduced only when the packet loss condition worsens after that (see Patent Document 2: Japanese Patent No. 3163479, for example).

This method has a problem that, if there is only one packet loss, the state of monitoring change in the number of losses while maintaining the CWND is entered, and the throughput does not increase. Furthermore, in the case where packet loss occurs at a high frequency, the congestion avoidance phase is not entered, and a state of waiting for an ACK corresponding to a resent random packet repeatedly occurs. As a result, the throughput does not increase, and the second conventional TCP problem is not solved.

Furthermore, this method also has a problem that, when a random loss packet is resent, it is not possible to newly transmit a packet during 1 RTT until after an ACK for the resent packet is returned, and the throughput is decreased during this time. In connection with this problem, fluctuation of the largest ACK number received by the sending side and the maximum transmittable sequence number will be described with the use of FIG. 13.

To simplify the description, the receiving-side buffer is assumed to be sufficiently large, and the maximum transmittable sequence number is assumed to be equal to [the largest ACK number notified by the receiving side]+CWND. It is assumed that the sending side sends data corresponding to the sequence numbers up to the maximum transmittable sequence number to the receiving side during the congestion avoidance phase before time A.

It is assumed that loss of a packet with the sequence number x is detected by the sending side at the time A, and that packets other than this packet have not been lost. In this case, the sending side performs the operation of resending the packet with the sequence number x without decreasing the CWND. After that, the ACK number sent by the sending side does not increase (an overlapping ACK) till the time B (=time A+1 RTT) when an ACK corresponding to the resent packet is returned. Therefore, the maximum transmittable sequence number remains x+CWND and does not change. Therefore, the sending side cannot transmit a packet with a new sequence number to the receiving side during this section.

At the time B, the sequence number of the ACK corresponding to the resent packet with the sequence number x becomes x+CWND, and the maximum transmittable sequence number becomes x+2CWND. Therefore, at this time, it is possible to send data corresponding to the CWND, and burst communication is performed.

In the conventional congestion control techniques described above, detection of congestion is performed based on simple change in the number of losses or explicit congestion information notified from a network. Therefore, though it is possible to perform congestion control according to change in a particular congestion situation, it is not possible to change the congestion control according to a wider range of congestion situation change.

Furthermore, the conventional congestion control techniques have a problem that, since resending of a loss pocket and the subsequent recovery phase repeatedly occur without entering the congestion avoidance phase, the throughput decreases in the case where the loss rate is high.

Furthermore the conventional congestion control techniques have a problem that, since the CWND and the largest ACK number on the receiving side does not change after loss of a packet and the maximum transmittable sequence number does not change, it is not possible to send a packet, and the throughput decreases after resending of the loss packet.

The object of the present invention is to provide a communication system capable of solving the above problems and capable of increasing throughput even in the case where the loss rate is high, only by changing the implementation of a sending-side terminal without necessity of changing the implementation of a receiving-side terminal or obtaining special information from a network, a communication apparatus, a congestion control method used therefor, and a program for the method.

### BRIEF SUMMARY OF THE INVENTION

The communication system according to the present invention is a communication system using a window control in which, when a receiving side recognizes packet loss, the receiving side specifies the lost packet and requests a sending side to resend the packet, wherein the sending side is provided with estimation means of estimating the congestion state of a network based on information notified by the receiving side and one or more pieces of information about the congestion control state, means of determining whether the state is a heavy congestion phase or not based on the congestion state estimated by the estimation means, and means of, when it is determined that the state is not the heavy congestion phase, resending the lost packet while increasing a window for determining the transmission amount of the packet.

The communication apparatus according to the present invention is a communication apparatus using a window control in which, when a receiving side recognizes packet loss, the receiving side specifies the lost packet and requests a sending side to resend the packet, wherein the sending side is provided with estimation means of estimating the congestion state of a network based on information notified by the receiving side and one or more pieces of information about the congestion control state, means of determining whether the state is a heavy congestion phase or not based on the congestion state estimated by the estimation means, and means of, when it is determined that the state is not the heavy congestion phase, resending the lost packet while increasing a window for determining the transmission amount of the packet.

The congestion control method according to the present invention is a communication method used for a communication system using a window control in which, when a receiving side recognizes packet loss, the receiving side specifies the lost packet and requests a sending side to resend the packet, wherein the sending side executes an estimation step of estimating the congestion state of a network based on information notified by the receiving side and one or more pieces of information about the congestion control state, a step of determining whether the state is a heavy congestion phase or not based on the congestion state estimated by the estimation means, and a step of, when it is determined that the state is not the heavy congestion phase, resending the lost packet while increasing a window for determining the transmission amount of the packet.

The program according to the present invention is a program of a communication method used for a communication system using a window control in which, when a receiving side recognizes packet loss, the receiving side specifies the lost packet and requests a sending side to resend the packet, the program causing a computer for performing processing of the sending side to execute estimation processing of estimating the congestion state of a network based on information notified by the receiving side and one or more pieces of information about the congestion control state, processing of determining whether the state is a heavy congestion phase or not based on the congestion state estimated by the estimation processing, and processing of, when it is determined that the state is not the heavy congestion phase, resending the lost packet while increasing a window for determining the transmission amount of the packet.

That is, in a first communication system of the present invention, a communication apparatus has a network state estimation section of estimating the congestion state of a network with the use of information about the state of packet loss or packet arrival time, and the state of congestion control, a light/heavy congestion determination section of determining whether congestion is light or heavy, a resending determination section of determining whether to perform resending or normal transfer in the case of light congestion, and a light congestion resending section of performing resending in the case of light congestion.

In the first communication system of the present invention, by adopting the above configuration to continuously increase the window even in the case of light congestion, it is possible to increase the throughput even when the loss rate is high only by changing the implementation of the sending-side terminal without necessity of changing the implementation of the receiving-side terminal or obtaining special information from the network.

Furthermore, in a second communication system of the present invention, a communication apparatus has a maximum transmittable sequence number correction section for increasing and correcting the maximum transmittable sequence number in addition to the above configuration. In the second communication system of the present invention, by adopting the above configuration to urge sending of a new packet even in the case of light congestion, it is possible to increase the throughput even when the loss rate is high only by changing the implementation of the sending-side terminal without necessity of changing the implementation of the receiving-side terminal or obtaining special information from the network, and to increase the throughput after resending of a loss packet.

According to the present invention, due to the configuration and the operation described above, an advantage of increasing throughput even when the loss rate is high only by changing the implementation of a sending-side terminal without necessity of changing the implementation of a receiving-side terminal or obtaining special information from a network can be obtained.

### BRIEF DESCRIPTION OF THE DRAWINGS

FIG. 1 is a block diagram showing the configuration of a communication system according to an embodiment of the present invention;

FIG. 2 is a block diagram showing the configuration of a session processing section of a sending terminal according to a first embodiment of the present invention;

FIG. 3 is a block diagram showing the configuration of a congestion control section in FIG. 2;

FIG. 4 is a flowchart showing the operation of the congestion control section in FIG. 3;

FIG. 5 is a block diagram showing the configuration of a congestion control section according to a second embodiment of the present invention;

FIG. 6 is a flowchart showing the operation of the congestion control section in FIG. 5;

FIG. 7 is a block diagram showing the configuration of a congestion control section according to a third embodiment of the present invention;

FIG. 8 is a flowchart showing the operation of the congestion control section in FIG. 7;

FIG. 9 is a block diagram showing the configuration of a congestion control section according to a fourth embodiment of the present invention;

FIG. 10 is a flowchart showing the operation of the congestion control section in FIG. 9;

FIG. 11 is a block diagram showing the configuration of a sending terminal according to a fifth embodiment of the present invention;

FIG. 12 is a sequence diagram showing the problem of throughput decrease caused when resending is performed, which is described in Patent Document 1 (Japanese Patent No. 3572111); and

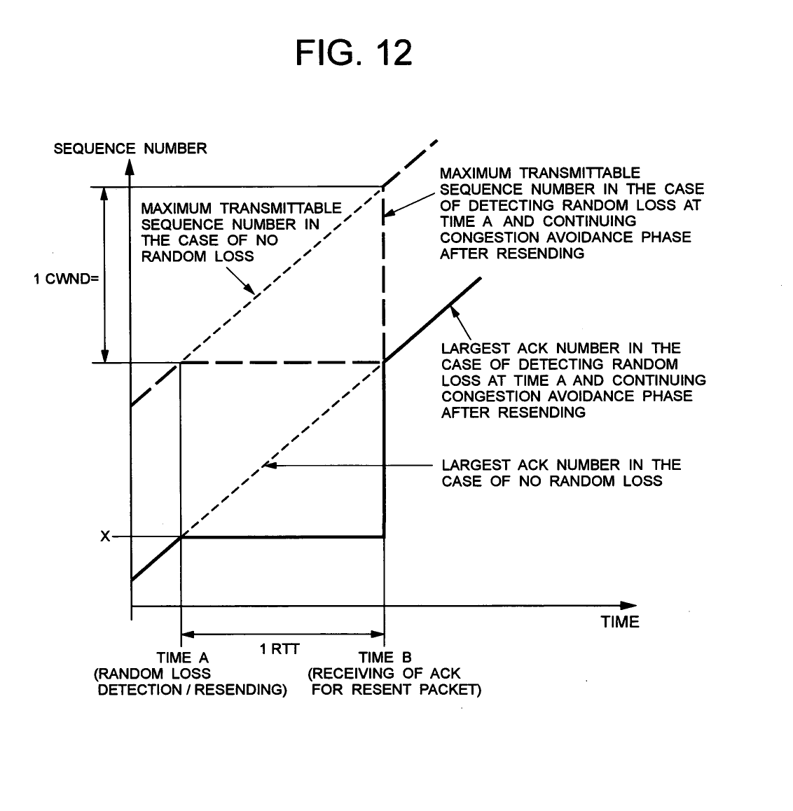

FIG. 13 is a sequence diagram showing the problem of throughput decrease caused when resending is performed, which is described in Patent Document 2 (Japanese Patent No. 3163479).

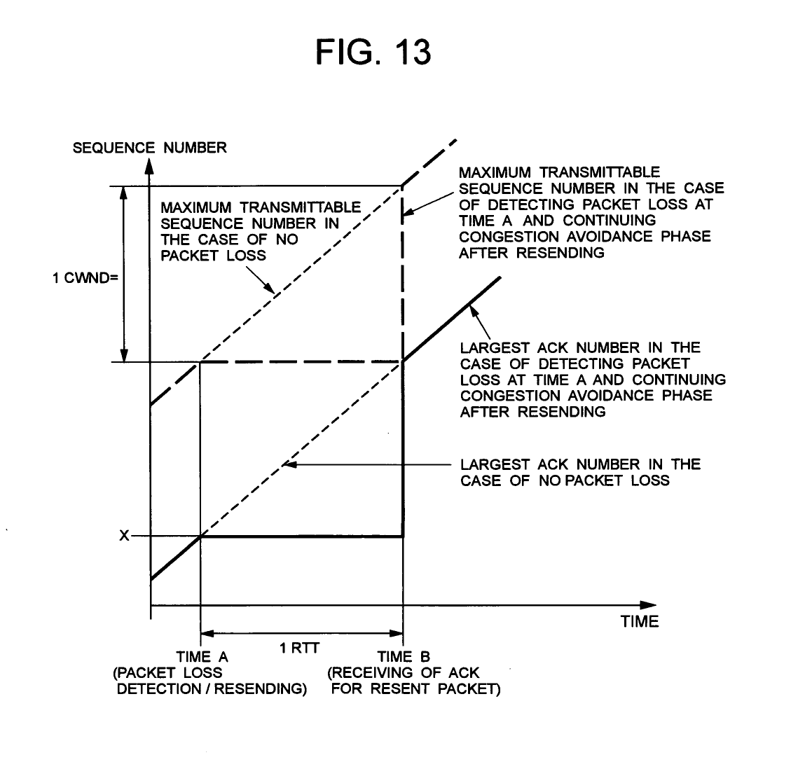

### DETAILED DESCRIPTION OF THE PREFERRED EMBODIMENTS

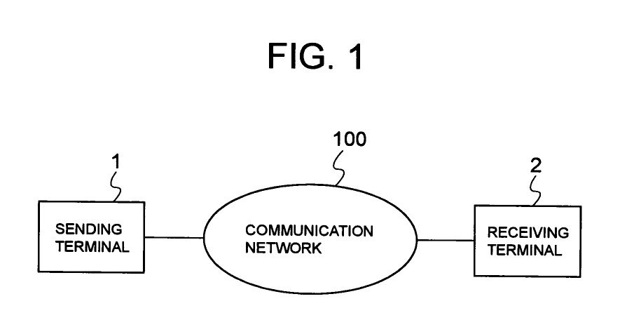

Next, embodiments of the present invention will be described with reference to drawings. FIG. 1 is a block diagram showing the configuration of a communication system according to an embodiment of the present invention. In FIG. 1, the communication system according to the embodiment of the present invention is configured by a sending terminal 1, a receiving terminal 2 and a communication network 100 for sending data from the sending terminal 1 to the receiving terminal 2.

In the communication system of the embodiment of the present invention, the sending terminal 1 is provided with a network state estimation section of estimating the congestion state of a network with the use of information about the state of packet loss or packet arrival time, and the state of congestion control, a light/heavy congestion determination section of determining whether congestion is light or heavy, a resending determination section of determining whether to perform resending or normal transfer in the case of light congestion, and a light congestion resending section of performing resending in the case of light congestion.

In the communication system according to the embodiment of the present invention, by adopting the above configuration to continuously increase the window even in the case of light congestion, it is possible to increase the throughput even when the loss rate is high, only by changing the implementation of the sending terminal 1 without necessity of changing the implementation of the receiving terminal 2 or obtaining special information from a network.

Furthermore, in the communication system according to the embodiment of the present invention, the sending terminal 1 is provided with a maximum transmittable sequence number correction section of increasing and correcting the maximum transmittable sequence number in addition to the above configuration. In the communication system according to the embodiment of the present invention, by adopting the above configuration to urge sending of a new packet even in the case of light congestion, it is possible to increase the throughput even when the loss rate is high and increase the throughput after resending of a loss packet, only by changing the implementation of the sending terminal 1 without necessity of changing the implementation of the receiving terminal 2 or obtaining special information from a network.

### First Embodiment

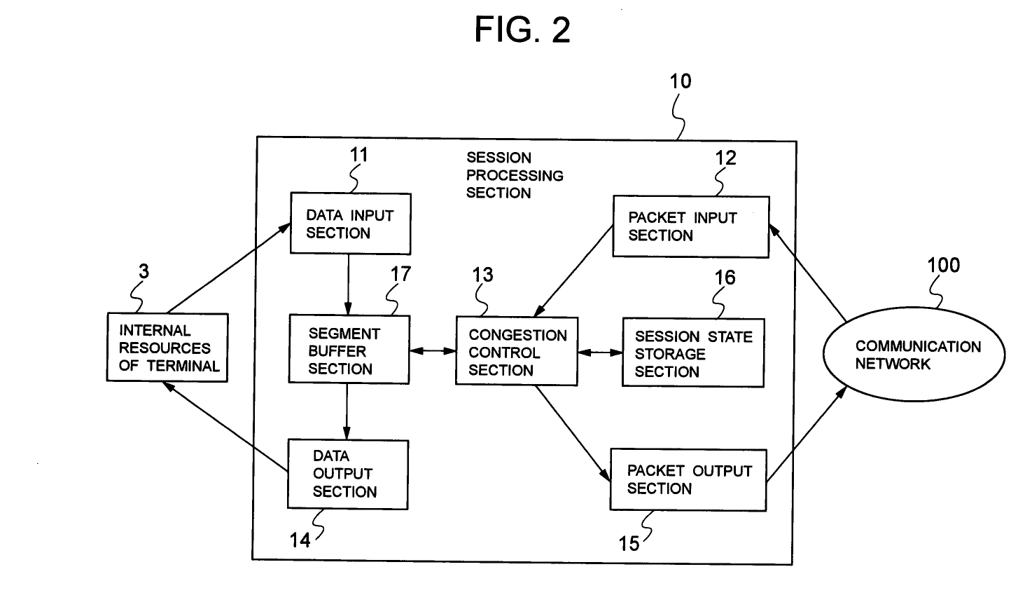

FIG. 2 is a block diagram showing the configuration of a session processing section of the sending terminal according to the first embodiment of the present invention. In FIG. 2, the session processing section 10 is configured by a data input section 11, a packet input section 12, a congestion control section 13, a data output section 14, a packet output section 15, a session state storage section 16 and a segment buffer section 17.

The sending terminal provided with this session processing section 10 is the sending terminal of the communication system according to the embodiment of the present invention shown in FIG. 1, and it sends data to the receiving terminal 2 via the communication network 100 similarly to the embodiment of the present invention. In the sending terminal 1, only the session processing section 10 will be described to simplify the description. Since the processing sections other than this session processing section 10 are well known, description thereof will be omitted.

As for the session processing section 10, description will be made only on the part related to congestion control by the sending side, of performing window-type congestion control by an ACK (acknowledgement) packet. Description on the parts related to session establishment/closing, data sending/receiving and sending of ACK will be omitted. It is assumed that data of a session flows in one direction.

The data input section 11 inputs data from internal resources of terminal 3, and the packet input section 12 inputs a packet from the communication network 100. The congestion control section 13 processes a signal from the data input section 11 and the packet input section 12. The data input section 14 sends data from the congestion control section 13 to the internal resources of terminal 3, and the packet output section 15 sends a packet from the congestion control section 13 to the communication network 100.

The session state storage section 16 holds information about a session to be processed by the congestion control section 13, and the segment buffer section 17 holds data from the data input section 11 to the data output section 14 by separating the data into segments each of which corresponds to a data portion in a packet.

As for the congestion control section 13, description will be made on processing related to ACK packet processing in session processing, and description on parts related to data sending/receiving processing and timer processing will be omitted.

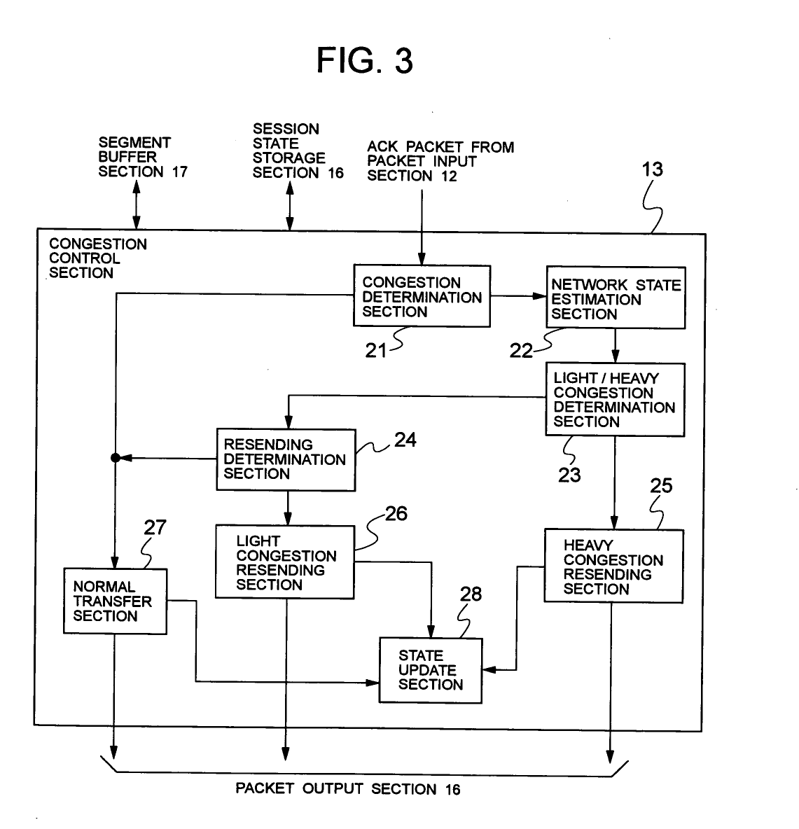

FIG. 3 is a block diagram showing the configuration of the congestion control section 13 in FIG. 2. In FIG. 3, the congestion control section 13 is provided with a congestion determination section 21, a network state estimation section 22, a light/heavy congestion determination section 23, a resending determination section 24, a heavy congestion resending section 25, a light congestion resending section 26, a normal transfer section 27 and a state update section 28.

The congestion determination section 21 determines whether the current state is a light/heavy congestion phase from ACK packets and the content stored in the session state storage section 16. If the current state is the light/heavy congestion phase, it hands the processing to the network state estimation section 22. Otherwise, it determines that the state is a normal phase and hands the processing to the normal transfer section 27. The network state estimation section 22 estimates the state of network congestion from ACK packets and the content stored in the session state storage section 16.

The light/heavy congestion determination section 23 determines whether the state is light congestion or heavy congestion from the result of the estimation by the network state estimation section 22. If the state is light congestion, it hands the processing to the resending determination section 24. If the state is heavy congestion, it hands the processing to the heavy congestion resending section 25. The resending determination section 24 determines whether there is any unresent segment which has not been resent from among segments required by ACK from the receiving side to be resent. If there is any unresent segment, it hands the processing to the light congestion resending section 26, and otherwise, it hands the processing to the normal transfer section 27.

The heavy congestion resending section 25 decreases the congestion window, searches for a segment to be resent from segments in the segment buffer section 17. If there is any segment to be resent, it hands the processing to the packet output section 15. The light congestion resending section 26 increases or maintains the congestion window or decreases the congestion window by the amount corresponding to the segment size of a resent packet, searches for a segment to be resent from the segments in the segment buffer section 17. If there is any segment to be resent, it hands the processing to the packet output section 15.

The normal transfer section 27 increases the congestion window, and if there is any new segment to be sent in the segment buffer section 17, it hands the processing to the packet output section 15. The state update section 28 updates the session state after the processings by the normal transfer section 27, the light congestion resending section 26 and the heavy congestion resending section 25 have been performed. The resending determination section 24 may re-resend a segment which has been resent once, again. The number of times of re-resending is not limited.

The timing of re-resending is when a new transmission sequence number is a number increased by x from the new sequence number at the time of resending or performing re-resending n times. The number x may be the plural, or it may be a value calculated from the congestion window size. It is the best to use the value of the congestion window as the number x because it is the smallest value among values effective as the control interval by the window control method.

The timing of re-resending may be when time t has elapsed after resending or after performing re-resending n times. The value t may be multiple values. The value t may be a value calculated from delay time or the interval of packet arrival. It is the best to use round-trip time as the value t because it is the smallest value among values effective as the control interval by the window control method.

In the network state estimation section 22, the congestion state of a network is estimated with the use of segment loss information, packet arrival time and congestion control state information from ACK packets and the content stored in the session state storage section 16. The segment loss information refers to information about the position of segment loss recognized by the receiving side based on segments which have arrived at the receiving side. The packet time information refers to delay time of packet arrival and the interval of packet arrival.

As the method for estimating the network congestion state from the segment loss information, there are three methods, that is: (a1) estimation based on fluctuation of the arrival pattern of new segments, (a2) estimation based on difference between the start and end sequences of a non-consecutive section of a segment, and (a3) estimation based on the amount of non-consecutive sections of a segment.

In the estimation method (a1), the network congestion state is estimated based on whether new segments arrive at the receiving side consecutively or non-consecutively. If new segments arrive non-consecutively, it is estimated that congestion worsens in comparison with the case where new segments arrive consecutively.

In the estimation method (a2), if the difference between the start and end sequences increases, it is estimated that congestion worsens. Determination on the increase may be performed based on whether the difference between the sequences becomes x. The value x may be a fixed value or a value calculated from the congestion window. In this estimation method, it is also possible to measure the sequence difference at constant time intervals and determine the network congestion state based on whether or not the value increases.

In the estimation method (a3), if the amount of non-consecutive sections of a segment increases, it is estimated that congestion worsens. The amount of non-consecutive sections of a segment refers to the amount of the non-consecutive section of a segment which is grasped by the sending side or the amount of the non-consecutive section of a segment in each notification from the receiving side. Determination of the decrease may be performed based on whether the amount of the non-consecutive section becomes x. The value x may be a fixed value or a value calculated from the congestion window. In this estimation method, it is also possible to measure the amount of non-consecutive sections at constant time intervals and determine the network congestion state based on whether or not the value increases. Furthermore, in this estimation method, it is also possible to assume that congestion worsens if the amount of one non-consecutive section increases.

As the method for estimating the network congestion state from the information about packet arrival time, there are two methods, that is: (b1) estimation based on how the delay time of packet arrival increases and (b2) estimation based on how the interval of packet arrival increases.

In the estimation method (b1), if the delay time of packet arrival increases, it is estimated that congestion worsens. As for determination on whether the arrival delay time tends to increase, it is determined that the arrival delay time tends to increase if the arrival delay time exceeds a threshold or if the average value or the deviation measured per unit time or both of them exceed a threshold or increase. Round-trip delay time is the most suitable to be used as the arrival delay time. This is because the round-trip delay time can be easily measured by using an ACK packet.

In the estimation method (b2), if the interval of packet arrival tends to increase, it is estimated that congestion worsens. As for determination on whether the arrival interval tends to increase, it is determined that the arrival interval tends to increase if the arrival interval exceeds a threshold or if the average value or the deviation measured per unit time or both of them exceed a threshold or increase.

As the method for estimating the network congestion state from the congestion control state, there are two methods, that is: (c1) estimation based on fluctuation of the number of times of re-resending and (c2) estimation based on congestion continuation time.

In the estimation method (c1), if the number of times of re-resending increases, it is estimated that congestion worsens. Determination on increase of the number of times of re-resending may be performed based on whether the number of times reaches x. The value x may be a fixed value or a value calculated from the congestion window. In this estimation method, it is also possible to measure the number of times of re-resending at constant time intervals and determine the network congestion state based on whether or not the value increases.

In the estimation method (c2), if the congestion continuation time continues to increase, it is estimated that congestion worsens. Determination on increase of the congestion continuation time may be performed based on whether the continuation time reaches the time t. The value t may be a fixed value or a value calculated from the arrival delay time or the arrival interval. In this estimation method, it is also possible to determine the network congestion state based on whether or not the current congestion continuation time increases by making comparison with the past congestion continuation time.

In the network state estimation section 22, any one or more of the above network congestion state estimation methods may be used. The best estimation method is to use all the estimation methods described above.

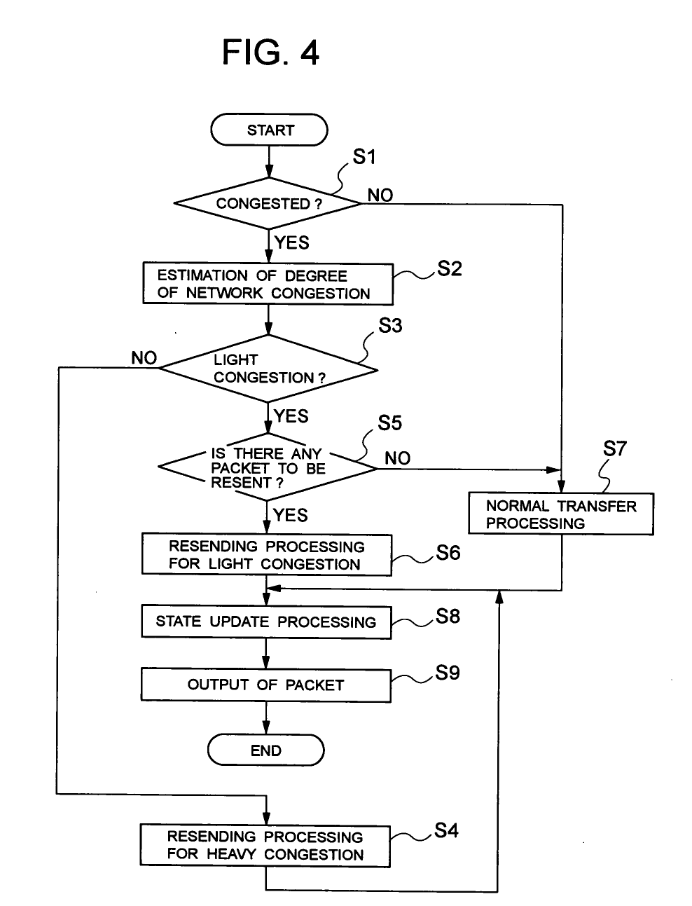

FIG. 4 is a flowchart showing the operation of the congestion control section 13 in FIG. 3. The operation of the congestion control section 13 according to the first embodiment of the present invention will be described with reference to FIGS. 1 to 4.

An ACK packet from the packet input section 12 is provided for the congestion determination section 21. At the congestion determination section 21, it is determined whether the network congestion state is light/heavy congestion (step S1 in FIG. 4). In the case of the light/heavy congestion, the processing is handed to the light/heavy congestion determination section 23. Otherwise, it is determined that the state is the normal phase, and the processing is handed to the normal transfer section 27.

The network state estimation section 22 estimates the network congestion state based on ACK packets and the content stored in the session state storage section 16 (step S2 in FIG. 4). The light/heavy congestion determination section 23 determines whether the current state is light congestion or heavy congestion from the result of the estimation by the network state estimation section 22 (step S3 in FIG. 4). In the case of light congestion, the processing is handed to the resending determination section 24, and otherwise, the processing is handed to the heavy congestion resending section 25.

The resending determination section 24 determines whether there is any unresent segment which has not been resent among segments which have been required by an ACK packet from the receiving side to be resent (step S5 in FIG. 4). If there is any segment to be resent, the processing is handed to the light congestion resending section 26, and otherwise, the processing is handed to the normal transfer section 27.

The heavy congestion resending section 25 decreases the congestion window and searches for a segment to be resent from segments in the segment buffer section 17. If there is any segment to be resent, the processing is handed to the packet output section 15 (step S4 in FIG. 4).

The light congestion resending section 26 increases or maintains the congestion window or decreases the congestion window by the amount corresponding to the segment size of a resent packet and searches for a segment to be resent, from the segments in the segment buffer section 17. If there is any segment to be resent, it hands the processing to the packet output section 15 (step S6 in FIG. 4).

The normal transfer section 27 increases the congestion window, and if there is any segment to be newly sent in the segment buffer section 17, the processing is handed to the packet output section 15 (step S7 in FIG. 4). After processing by each of the normal transfer section 27, the light congestion resending section 26 and the heavy congestion resending section 25 is performed, the state update section 28 updates the session state (step S8 in FIG. 4). After that, the packet output section 15 outputs the packet to the communication network 100 based on the processing by each of the normal transfer section 27, the light congestion resending section 26 and the heavy congestion resending section 25 (step S9 in FIG. 4).

Though the congestion determination section 21 and the light/heavy congestion determination section 23 are separately provided in this embodiment, they may be combined into one determination section as a normal phase/light/heavy congestion determination section. In this embodiment, the section may be divided into a portion for determining a normal phase/light congestion or heavy congestion, and a portion for determining normal or light congestion. That is, in this embodiment, it is sufficient if the three phases can be determined as a result.

Furthermore, in this embodiment, the light congestion resending section 26 may perform the processing by the normal transfer section 27 after performing light congestion resending processing. Furthermore, in this embodiment, the window may be kept by the heavy congestion resending section 25. Furthermore, in this embodiment, the window may be increased by the increase amount less than that of the normal transfer section 27, and re-resending may be performed similarly to the case of light congestion.

Next, description will be made on the case of using TCP (also referred to as Transmission Control Protocol or Transport Control Protocol) as the congestion control method in the first embodiment of the present invention.

If the phase held in the session state storage section 16 is the normal phase, then the congestion determination section 21 determines whether or not the handed ACK packet is an overlapping ACK and whether or not the overlapping ACK threshold is exceeded. If the overlapping ACK threshold is exceeded, then the phase turns into the congestion phase, and the processing is handed to the light/heavy congestion determination section 23.

If the phase held in the session state storage section 16 is the congestion phase, then the congestion determination section 21 determines whether there is not any non-consecutive sequence section notified from the receiving side by the SACK (selective ACK) option.

If there is not any non-consecutive sequence section, then the congestion determination section 21 determines that the phase has turned into the normal phase, and hands the processing to the normal transfer section 27. If there is any non-consecutive sequence section, then the congestion determination section 21 hands the processing to the light/heavy congestion determination section 23.

As for the method for determining whether there is not non-consecutive sequence section anymore, the determination is made based on whether SACK information is not included in an ACK packet any more, or whether there is not any SACK consecutive section with the sequence number equal to or above the ACK sequence number of an ACK packet, among SACK consecutive sections held in the session state storage section 16.

In the network state estimation section 22, the congestion state of a network is estimated with the use of segment loss information, packet arrival time and congestion control state information from ACK packets and the content stored in the session state storage section 16.

As the method for estimating the network congestion state from the segment loss information, there are four methods, that is: (d1) congestion is estimated to be worse if the latest received sequence number notified from the receiving side by the SACK option is overlapping and it exceeds a threshold, (d2) congestion is estimated to be worse if difference between the largest sequence number among the sent sequence numbers of sequences transmitted by the sending side (the largest sent sequence number) and the ACK number exceeds X×[congestion window size] (X is any-value equal to or above 1), (d3) congestion is estimated to be worse if difference between the latest received sequence number notified from the receiving side by the SACK option and the ACK number exceeds the Y×[congestion window size] (Y is any value larger than 0), and (d4) congestion is estimated to be worse if the amount of non-consecutive sections calculated from consecutive sections notified from the receiving side by the SACK option exceeds Z×[congestion window size] (Z is any value larger than 0 and less than 1).

As the method for estimating the network congestion state from the information about packet arrival time, there are two methods, that is: (e1) congestion is estimated to be worse if the deviation of round-trip delay time of packet exceeds X×[average value] (X is any value larger than 0) and (e2) congestion is estimated to be worse if the deviation of the packet arrival interval exceeds Y×[average value] (Y is any value larger than 0).

As the method for estimating the network congestion state from the congestion control state, there are two methods, that is: (f1) congestion is estimated to be worse if the fluctuation of the number of times of re-resending exceeds X times (X is an integer value larger than 0) and (f2) congestion is estimated to be worse if congestion continuation time exceeds time Y×[round-trip delay time] (Y is a value larger than 0).

In this embodiment, any one or more of the above network congestion state estimation methods may be used in the network state estimation section 22. The best method is to use all the methods.

If the phase held in the session state storage section 16 is not heavy congestion, the light/heavy congestion determination section 23 determines whether or not the phase has turned into heavy congestion based on the result of the estimation by the network state estimation section 22. If the phase turns into heavy congestion, the processing is handed to the heavy congestion resending section 25, and otherwise, the processing is handed to the resending determination section 24. If the phase held in the session state storage section 16 is heavy congestion, the light/heavy congestion determination section 23 determines whether or not the heavy congestion continues based on the result of the estimation by the network state estimation section 22. If the heavy congestion continues, the processing is handed to the heavy congestion resending section 25. If the heavy congestion does not continue any more, the processing is handed to the resending determination section 24.

The resending determination section 24 determines whether there is any unresent segment which has not been resent among segments which have been required by the receiving side to be resent. If there is any unresent segment, the processing is handed to the light congestion resending section 26, and otherwise, the processing is handed to the normal transfer section 27.

The sending side calculates a section required by the receiving side to be resent, from the sequence number of ACK and the SACK option. The sequence number of ACK refers to the largest sequence number among sequence numbers consecutively received, and the SACK option notifies consecutive sections among sections caused to be non-consecutive due to packet loss, from the receiving side to the sending side. Therefore, from the information, the sending side can calculate segment sections which have not been received by the receiving side.

The light congestion resending section 26 creates a packet to be resent or re-resent from segments held in the segment buffer section 17. In this case, the congestion window may not be changed or changed by the amount corresponding to the size of the created segment. The slow start threshold is not updated, and a flag indicating that normal resending is being performed is not raised. That is, only the packet is resent or re-resent. The heavy congestion resending section 25 decreases the congestion window to half and performs high-speed resending or high-speed retransfer.

### Second Embodiment

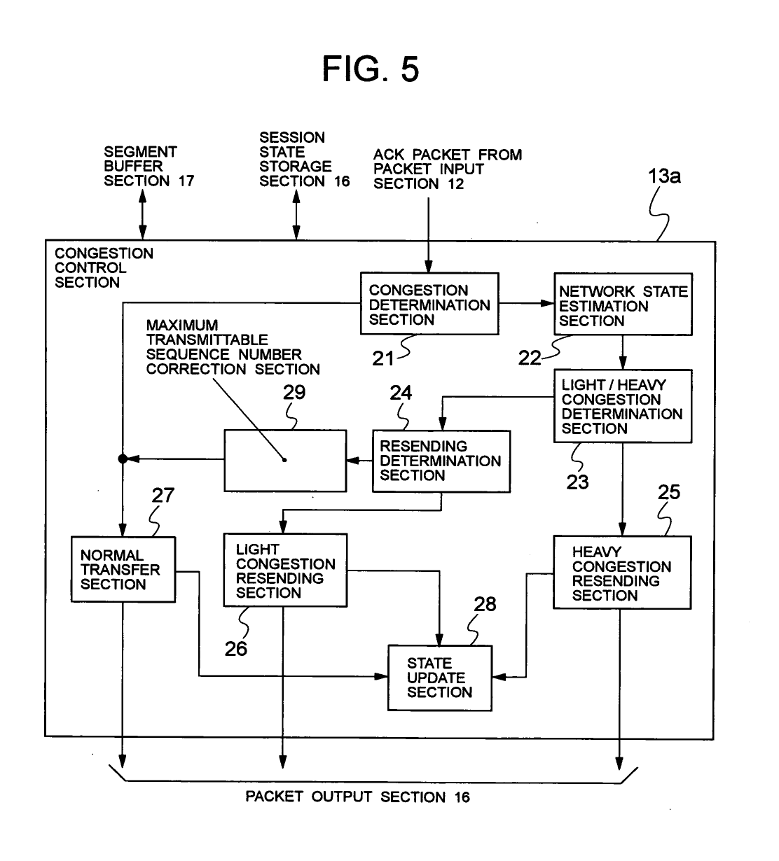

FIG. 5 is a block diagram showing the configuration of a congestion control section according to a second embodiment of the present invention. In FIG. 5, the configuration of the congestion control section 13a according to the second embodiment of the present invention is similar to that of the congestion control section 13 according to the first embodiment of the present invention shown in FIG. 3 except that a maximum transmittable sequence number correction section 29 is added, and the same reference numerals are given to the same components. The operations of the same components are similar to those in the first embodiment of the present invention. The configuration of a communication system according to the second embodiment of the present invention is similar to that of the communication system of the embodiment of the present invention shown in FIG. 1, and the configuration of a session processing section according to the second embodiment of the present invention is similar to that of the session processing section 10 of the first embodiment of the present invention shown in FIG. 2.

In the second embodiment of the present invention, after it is determined by a resending determination section 24 that resending is not to be performed, processing by the maximum transmittable sequence number correction section 29 is executed before the processing by a normal transfer section 27 is performed. The maximum transmittable sequence number correction section 29 urges the normal transfer section 27 to send a new packet even in the case of light congestion, by increasing and correcting the maximum transmittable sequence number. The corrected maximum transmittable sequence number is used for processing in the normal transfer section 27, and it is not held in a state update section 28.

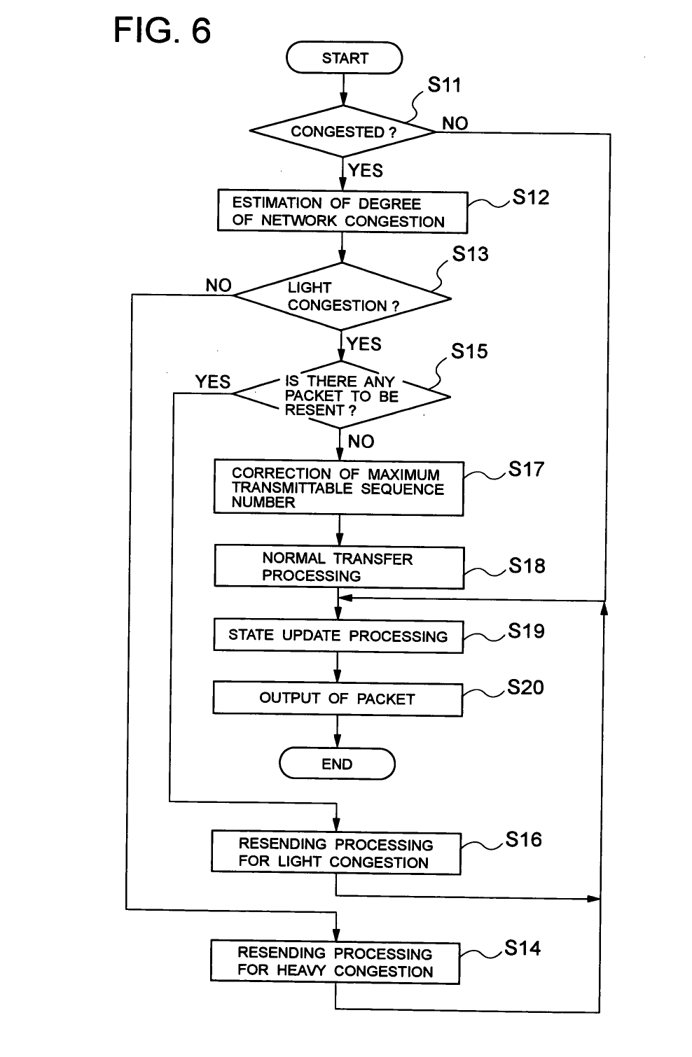

FIG. 6 is a flowchart showing the operation of the congestion control section 13a in FIG. 5. The operation of the congestion control section 13a according to the second embodiment of the present invention will be described with reference to FIGS. 1, 2, 5 and 6. Since the processings at steps S11 to S16 and S18 to S20 in FIG. 6 are similar to those at steps S1 to S9 in FIG. 4, description of the processings will be omitted.

When it is determined by the resending determination section 24 that there is not any unresent segment which has not been resent among segments required by an ACK packet from the receiving side to be resent (step S15 in FIG. 6), the maximum transmittable sequence number correction section 29 increases and corrects the maximum transmittable sequence number (step S17 in FIG. 6) and hands the processing to the normal transfer section 27.

Next, description will be made on the case of using TCP as the session protocol in the second embodiment of the present invention.

To describe how the maximum transmittable sequence number correction section 29 corrects the maximum transmittable sequence number, the maximum transmittable sequence number correction section 29 makes correction by adding X of any value to cause the maximum transmittable sequence number to be “the largest ACK sequence number notified by sending side+congestion window size+X” though the normal maximum transmittable sequence number is indicated by “the largest ACK sequence number notified from the sending side+congestion window size”. The value X may be a fixed value or a value proportionate to the congestion window.

In this embodiment, the maximum transmittable sequence number may be “the latest received sequence number notified by the SACK option from the receiving side+congestion window size”.

### Third Embodiment

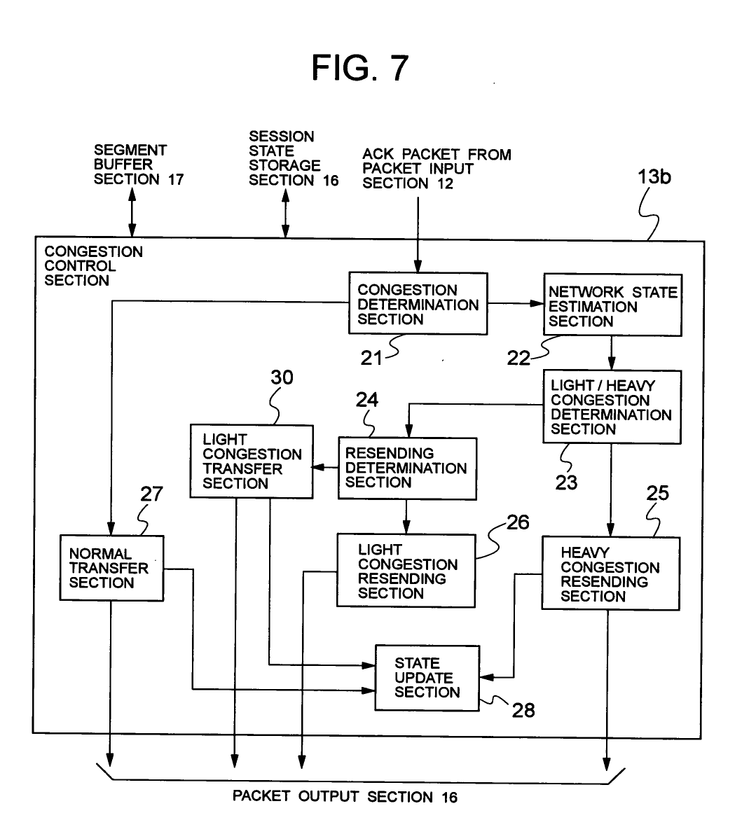

FIG. 7 is a block diagram showing the configuration of a congestion control section according to a third embodiment of the present invention. In FIG. 7, the configuration of the congestion control section 13b according to the third embodiment of the present invention is similar to that of the congestion control section 13 according to the first embodiment of the present invention shown in FIG. 3 except that a light congestion transfer section 30 is provided, and the same reference numerals are given to the same components. The operations of the same components are similar to those in the first embodiment of the present invention. The configuration of a communication system according to the third embodiment of the present invention is similar to that of the communication system of the embodiment of the present invention shown in FIG. 1, and the configuration of a session processing section according to the third embodiment of the present invention is similar to that of the session processing section 10 of the first embodiment of the present invention shown in FIG. 2.

In the third embodiment of the present invention, when it is determined by a resending determination section 24 that there is not any unresent segment which has not been resent among segments required by an ACK from the receiving side to be resent, the processing is handed to the light congestion transfer section 30. The light congestion transfer section 30 performs congestion control different from that by the normal transfer section 27. This different congestion control refers to such control that the amount of increase of the congestion window is less in comparison with the case of the normal transfer section 27 or control of maintaining the congestion window for some time and then increasing the congestion window.

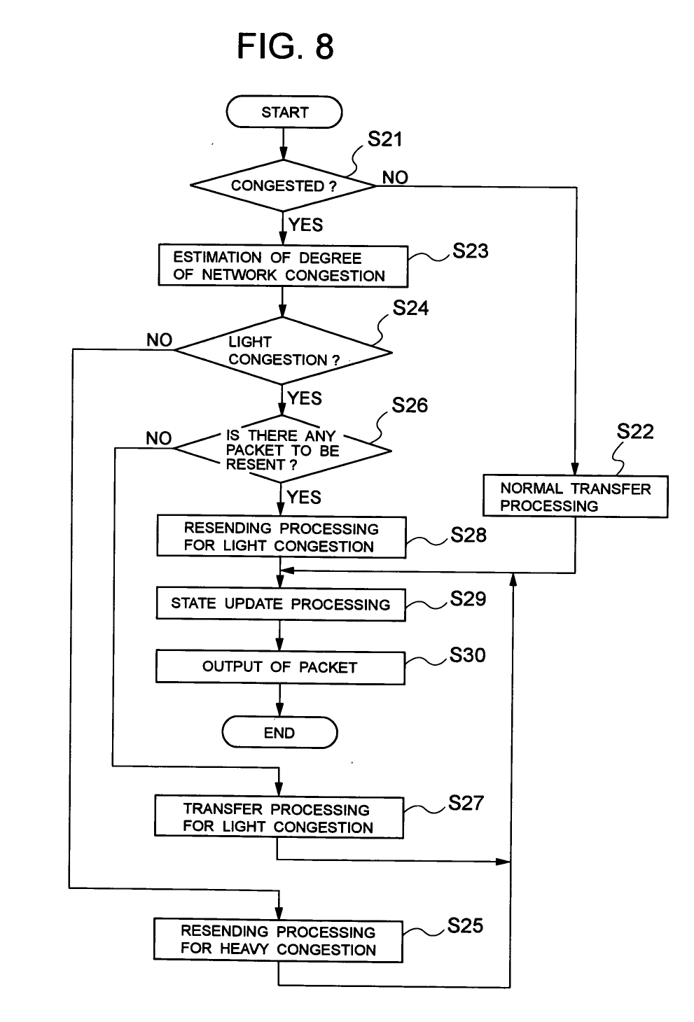

FIG. 8 is a flowchart showing the operation of the congestion control section 13b in FIG. 7. The operation of the congestion control section 13b according to the third embodiment of the present invention will be described with reference to FIGS. 1, 2, 7 and 8. Since the processings at steps S21 to S26 and S28 to S30 in FIG. 8 are similar to those at steps S1 to S9 in FIG. 4, description of the processings will be omitted.

When it is determined by the resending determination section 24 that there is not any unresent segment which has not been resent among segments required by an ACK packet from the receiving side to be resent (step S26 in FIG. 8), the light congestion transfer section 30 performs transfer processing for light congestion (step S27 in FIG. 8).

### Fourth Embodiment

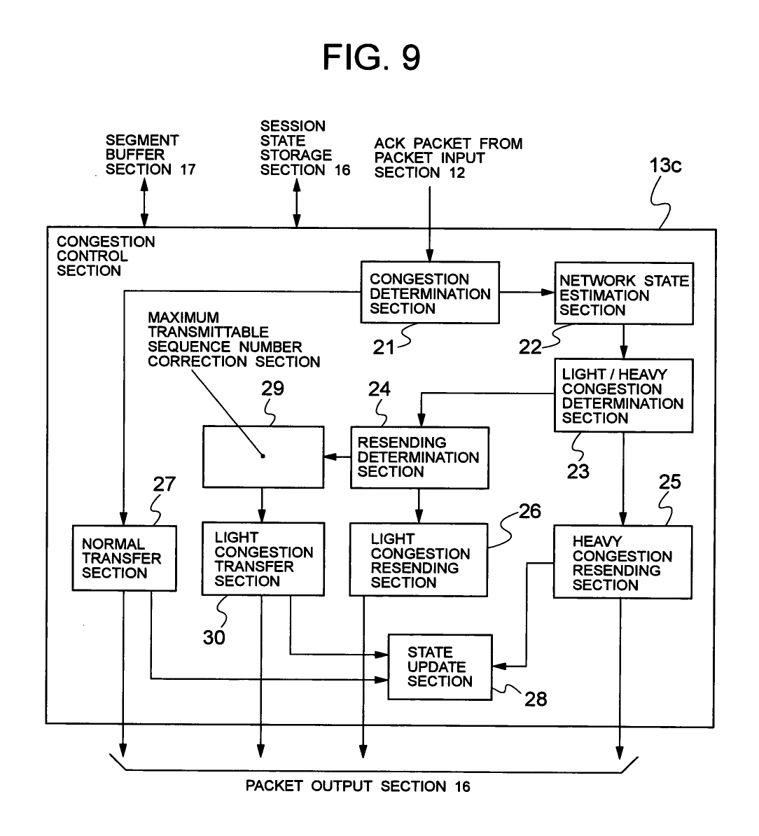

FIG. 9 is a block diagram showing the configuration of a congestion control section according to a fourth embodiment of the present invention. In FIG. 9, the configuration of the congestion control section 13c according to the fourth embodiment of the present invention is similar to that of the congestion control section 13b according to the third embodiment of the present invention shown in FIG. 7 except that a maximum transmittable sequence number correction section 29 is provided, and the same reference numerals are given to the same components. The operations of the same components are similar to those in the third embodiment of the present invention. The configuration of a communication system according to the fourth embodiment of the present invention is similar to that of the communication system of the embodiment of the present invention shown in FIG. 1, and the configuration of a session processing section of the fourth embodiment of the present invention is similar to that of the session processing section 10 of the first embodiment of the present invention shown in FIG. 2.

In the fourth embodiment of the present invention, after it is determined by a resending determination section 24 that there is not any unresent segment which has not been resent among segments required by an ACK from the receiving side to be resent, the processing by the maximum transmittable sequence number correction section 29 is executed before processing by the light congestion transfer section 30 is performed.

The maximum transmittable sequence number correction section 29 urges the light congestion transfer section 30 to perform congestion control different from that by the normal transfer section 27, in the case of light congestion by increasing and correcting the maximum transmittable sequence number. The corrected maximum transmittable sequence number is used for processing in the light congestion transfer section 30, and it is not held in a state update section 28.

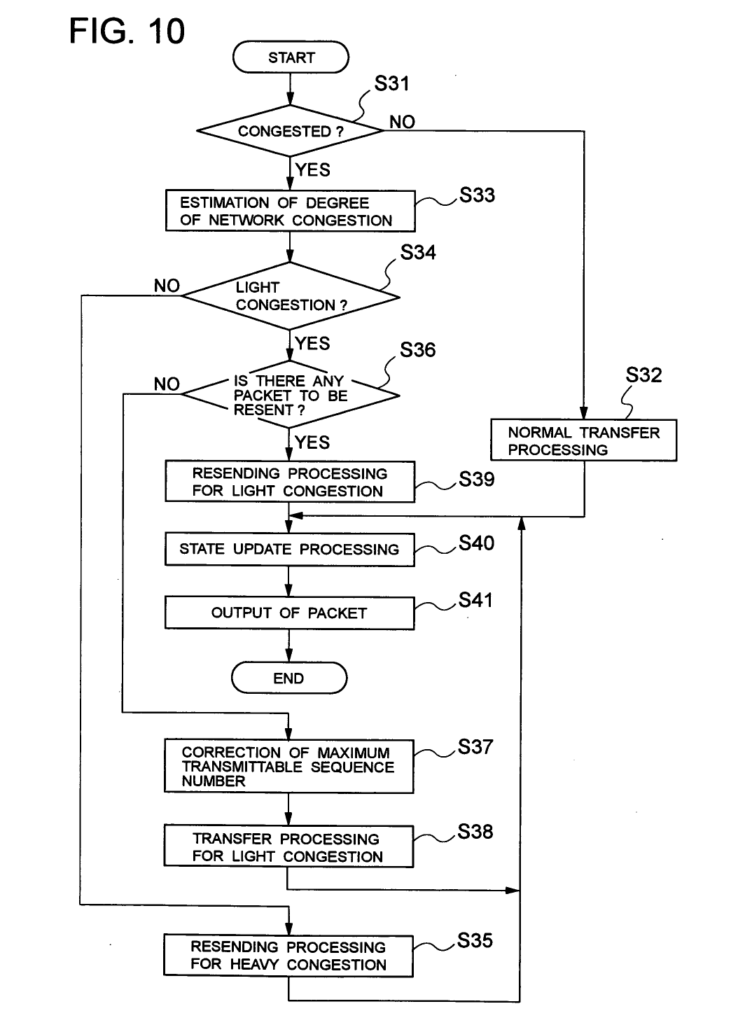

FIG. 10 is a flowchart showing the operation of the congestion control section 13c in FIG. 9. The operation of the congestion control section 13c according to the fourth embodiment of the present invention will be described with reference to FIGS. 1, 2, 9 and 10. Since the processings at steps S31 to S36 and S38 to S40 in FIG. 10 are similar to those at steps S21 to S30 in FIG. 8, description of the processings will be omitted.

When it is determined by the resending determination section 24 that there is not any unresent segment which has not been resent among segments required by an ACK packet from the receiving side to be resent (step S36 in FIG. 10), the maximum transmittable sequence number correction section 29 increases and corrects the maximum transmittable sequence number (step S37 in FIG. 10) and hands the processing to the light congestion transfer section 30. The light congestion transfer section 30 performs transfer processing for light congestion (step S38 in FIG. 10).

### Fifth Embodiment

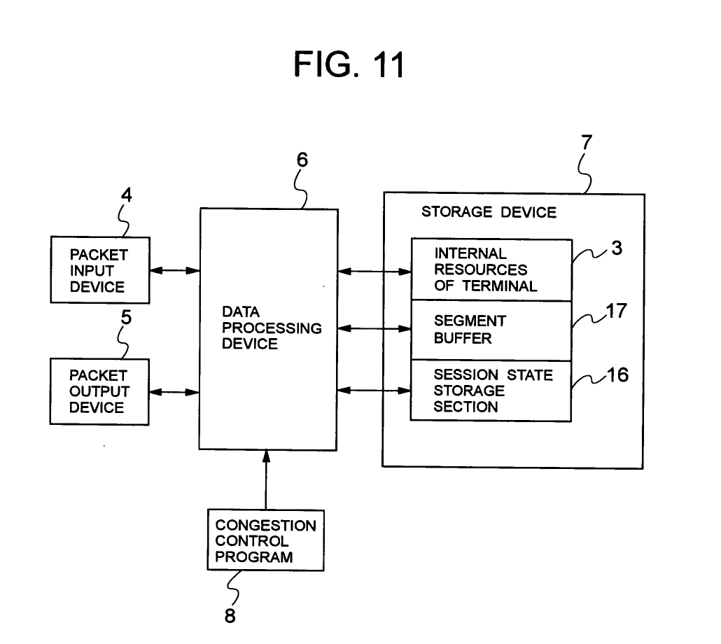

FIG. 11 is a block diagram showing the configuration of a sending terminal according to a fifth embodiment of the present invention. In FIG. 11, the sending terminal according to the fifth embodiment of the present invention is provided with a packet input device 4, a packet output device 5, a data processing device 6, a storage device 7 and a congestion control program 8.

The congestion control program 8 is read into the data processing device 6, and it controls the operation of the data processing device 6, generates a segment buffer section 17 and a session state storage section 16 in the storage device 7, exchanges data with internal resources of terminal 3 and exchanges packets with the packet input device 4 and the packet output device 5.

Under the control of the congestion control program 8, the data processing device 6 executes the same processings as those by the data input section 11, the data output section 14, the congestion control section 13, the packet input section 12 and the packet output section 15 in the first to fourth embodiments of the present invention described above.

Thus, the processing operations according to the first to fourth embodiments of the present invention described above are realized by the data processing device 6 performing processing operations based on the control by the congestion control program 8.

In each of the above embodiments of the present invention, description has been made on the case where there are two kinds of congestion phases. However, there may be three or more kinds of congestion phases. That is, the light congestion may be divided into two or more kinds. Furthermore, the heavy congestion may be divided into two or more kinds.

In each of the above embodiments of the present invention, description has been made on the case where two terminals are used. However, the number of terminals is not limited. Furthermore, in each of the above embodiments of the present invention, description has been made on the case of one-way communication. However, bidirectional communication is also possible. Furthermore, in each of the above embodiments of the present invention, description has been made on the case where the sending terminal 1 and the receiving terminal 2 are separate terminals. However, the functions of the sending terminal 1 and the receiving terminal 2 may be provided for the same terminal. In this case, each of the sending terminal 1 and the receiving terminal 2 may be a session repeater.

In the present invention, even if random loss is the actual cause of congestion, the random loss is determined to be light congestion, and therefore, the object of the present invention can be achieved even under such an environment.

The present invention is applicable to session communication by terminals, and especially for the purpose of TCP communication. Furthermore, the present invention is also applicable to a session repeater such as a proxy and a cryptographic apparatus.

What is claimed is:

1. A communication system using a window control in which, when a receiving side recognizes packet loss, the receiving side specifies the lost packet and requests a sending side to resend the packet, wherein
the sending side comprises estimation means of estimating the congestion state of a network based on information notified by the receiving side and one or more pieces of information about the congestion control state, means of determining whether the state is a heavy congestion phase or not based on the congestion state estimated by the estimation means, and means of, when it is determined that the state is not the heavy congestion phase, resending the lost packet while increasing a window for determining the transmission amount of the packet.

2. The communication system according to claim 1, wherein
the sending side performs re-resending of the packet, and
the congestion control state used by the estimation means to estimate the congestion state of the network is the number of times of re-resending the packet.

3. The communication system according to claim 1, wherein the congestion control state used by the estimation means to estimate the congestion state of the network is how the arrival interval of the packet increases.

4. The communication system according to claim 1, wherein the information notified by the receiving side to the sending side is any one or more of the position of segment loss and the arrival time of the packet.

5. The communication system according to claim 4, wherein the estimation means uses fluctuation of the arrival pattern of a new segment to estimate the congestion state of the network.

6. The communication system according to claim 4, wherein the estimation means uses difference between the start and end sequences of a non-consecutive section of a segment to estimate the congestion state of the network.

7. The communication system according to claim 4, wherein the estimation means uses the amount of non-consecutive sections of a segment to estimate the congestion state of the network.

8. The communication system according to claim 4, wherein the estimation means uses how the arrival delay time of the packet increases to estimate the congestion state of the network.

9. The communication system according to claim 4, wherein the estimation means uses how the arrival interval of the packet increases to estimate the congestion state of the network.

10. The communication system according to claim 1, wherein the sending side comprises means of, when it is determined that the state is the heavy congestion phase, resending the lost packet while decreasing the window.

11. The communication system according to claim 1, wherein the sending side comprises means of, when it is determined that the state is the heavy congestion phase, resending the lost packet while maintaining the window.

12. The communication system according to claim 1, wherein the sending side comprises means of, when it is determined that the state is the heavy congestion phase, resending the lost packet while increasing the window by a less increase amount in comparison with the case where the state is not the heavy congestion phase.

13. The communication system according to claim 1, wherein the sending side comprises light congestion resending means of, when it is determined that the state is a light congestion phase, resending a segment which has not been resent among segments requested to be resent while increasing the window.

14. The communication system according to claim 1, wherein the sending side comprises light congestion resending means of, when it is determined that the state is a light congestion phase, resending a segment which has not been resent among segments requested to be resent while maintaining the window.

15. The communication system according to claim 1, wherein the sending side comprises light congestion resending means of, when it is determined that the state is a light congestion phase, resending a segment which has not been resent among segments requested to be resent while reducing the window by the amount corresponding to the segment size of the resent packet.

16. The communication system according to claim 1, wherein the sending side comprises maximum transmittable sequence number correction means of, when it is determined that the state is a light congestion phase, increasing the maximum value of a newly transmittable sequence number.

17. The communication system according to claim 1, wherein the sending side comprises maximum transmittable sequence number correction means of, when it is determined that the state is a light congestion phase, changing the maximum value of a newly transmittable sequence number to “the receiving-side largest received sequence number+congestion window size”.

18. The communication system according to claim 1, wherein the sending side comprises normal transfer means of, when the network is not in a congestion phase, sending a new packet while increasing the window and light congestion transfer means of, when it is determined that there is not any unresent segment among segments requested to be resent, sending the new packet while increasing the window by an increase amount less than that of the normal transfer means.

19. The communication system according to claim 1, wherein the sending side comprises normal transfer means of, when the network is not in a congestion phase, sending a new packet while increasing the window and light congestion transfer means of, when it is determined that there is not any unresent segment among segments requested to be resent, maintaining the window for a predetermined time and then sending the new packet while increasing the window.

20. A communication apparatus using a window control in which, when a receiving side recognizes packet loss, the receiving side specifies the lost packet and requests a sending side to resend the packet, wherein
processing means of the sending side comprises estimation means of estimating the congestion state of a network based on information notified by the receiving side and one or more pieces of information about the congestion control state, means of determining whether the state is a heavy congestion phase or not based on the congestion state estimated by the estimation means, and means of, when it is determined that the state is not the heavy congestion phase, resending the lost packet while increasing a window for determining the transmission amount of the packet.

21. The communication apparatus according to claim 20, wherein
the processing means of the sending side performs re-resending of the packet, and
the congestion control state used by the estimation means to estimate the congestion state of the network is the number of times of re-resending the packet.

22. The communication apparatus according to claim 20, wherein the congestion control state used by the estimation means to estimate the congestion state of the network is how the arrival interval of the packet increases.

23. The communication apparatus according to claim 20, wherein the information notified by the receiving side to the processing means of the sending side is any one or more of the position of segment loss and the arrival time of the packet.

24. The communication apparatus according to claim 23, wherein the estimation means uses fluctuation of the arrival pattern of a new segment to estimate the congestion state of the network.

25. The communication apparatus according to claim 23, wherein the estimation means uses difference between the start and end sequences of a non-consecutive section of a segment to estimate the congestion state of the network.

26. The communication apparatus according to claim 23, wherein the estimation means uses the amount of non-consecutive sections of a segment to estimate the congestion state of the network.

27. The communication apparatus according to claim 23, wherein the estimation means uses how the arrival delay time of the packet increases to estimate the congestion state of the network.

28. The communication apparatus according to claim 23, wherein the estimation means uses how the arrival interval of the packet increases to estimate the congestion state of the network.

29. The communication apparatus according to claim 20, wherein the processing means of the sending side comprises means of, when it is determined that the state is the heavy congestion phase, resending the lost packet while decreasing the window.

30. The communication apparatus according to claim 20, wherein the processing means of the sending side comprises means of, when it is determined that the state is the heavy congestion phase, resending the lost packet while maintaining the window.

31. The communication apparatus according to claim 20, wherein the processing means of the sending side comprises means of, when it is determined that the state is the heavy congestion phase, resending the lost packet while increasing the window by a less increase amount in comparison with the case where the state is not the heavy congestion phase.

32. The communication apparatus according to claim 20, wherein the processing means of the sending side comprises light congestion resending means of, when it is determined that the state is a light congestion phase, resending a segment which has not been resent among segments requested to be resent while increasing the window.

33. The communication apparatus according to claim 20, wherein the processing means of the sending side comprises light congestion resending means of, when it is determined that the state is a light congestion phase, resending a segment which has not been resent among segments requested to be resent while maintaining the window.

34. The communication apparatus according to claim 20, wherein the processing means of the sending side comprises light congestion resending means of, when it is determined that the state is a light congestion phase, resending a segment which has not been resent among segments requested to be resent while reducing the window by the amount corresponding to the segment size of the resent packet.

35. The communication apparatus according to claim 20, wherein the processing means of the sending side comprises maximum transmittable sequence number correction means of, when it is determined that the state is a light congestion phase, increasing the maximum value of a newly transmittable sequence number.

36. The communication apparatus according to claim 20, wherein the processing means of the sending side comprises maximum transmittable sequence number correction means of, when it is determined that the state is a light congestion phase, changing the maximum value of a newly transmittable sequence number to “the receiving-side largest received sequence number+congestion window size”.

37. The communication apparatus according to claim 20, wherein the processing means of the sending side comprises normal transfer means of, when the network is not in a congestion phase, sending a new packet while increasing the window and light congestion transfer means of, when it is determined that there is not any unresent segment among segments requested to be resent, sending the new packet while increasing the window by an increase amount less than that of the normal transfer means.

38. The communication apparatus according to claim 20, wherein the processing means of the sending side comprises normal transfer means of, when the network is not in a congestion phase, sending a new packet while increasing the window and light congestion transfer means of, when it is determined that there is not any unresent segment among segments requested to be resent, maintaining the window for a predetermined time and then sending the new packet while increasing the window.

39. A communication method used for a communication system using a window control in which, when a receiving side recognizes packet loss, the receiving side specifies the lost packet and requests a sending side to resend the packet, wherein
an apparatus of the sending side executes estimation processing for estimating the congestion state of a network based on information notified by the receiving side and one or more pieces of information about the congestion control state, processing for determining whether the state is a heavy congestion phase or not based on the congestion state estimated by the estimation means, and processing for, when it is determined that the state is not the heavy congestion phase, resending the lost packet while increasing a window for determining the transmission amount of the packet.

40. The congestion control method according to claim 39, wherein
the apparatus of the sending side performs re-resending of the packet, and
the congestion control state used in the estimation processing to estimate the congestion state of the network is the number of times of re-resending the packet.

41. The congestion control method according to claim 39, wherein the congestion control state used in the estimation processing to estimate the congestion state of the network is how the arrival interval of the packet increases.

42. The congestion control method according to claim 39, wherein the information notified by the receiving side to the apparatus of the sending side is any one or more of the position of segment loss and the arrival time of the packet.

43. The congestion control method according to claim 42, wherein fluctuation of the arrival pattern of a new segment is used in the estimation processing to estimate the congestion state of the network.

44. The congestion control method according to claim 42, wherein difference between the start and end sequences of a non-consecutive section of a segment is used in the estimation processing to estimate the congestion state of the network.

45. The congestion control method according to claim 42, wherein the amount of non-consecutive sections of a segment is used in the estimation processing to estimate the congestion state of the network.

46. The congestion control method according to claim 42, wherein how the arrival delay time of the packet increases is used in the estimation processing to estimate the congestion state of the network.

47. The congestion control method according to claim 42, wherein how the arrival interval of the packet increases is used in the estimation processing to estimate the congestion state of the network.

48. The congestion control method according to claim 39, wherein the apparatus of the sending side executes processing for, when it is determined that the state is the heavy congestion phase, resending the lost packet while decreasing the window.

49. The congestion control method according to claim 39, wherein the apparatus of the sending side executes processing for, when it is determined that the state is the heavy congestion phase, resending the lost packet while maintaining the window.

50. The congestion control method according to claim 39, wherein the apparatus of the sending side executes processing for, when it is determined that the state is the heavy congestion phase, resending the lost packet while increasing the window by a less increase amount in comparison with the case where the state is not the heavy congestion phase.

51. The congestion control method according to claim 39, wherein the apparatus of the sending side executes light congestion resending processing for, when it is determined that the state is a light congestion phase, resending a segment which has not been resent among segments requested to be resent while increasing the window.

52. The congestion control method according to claim 39, wherein the apparatus of the sending side executes light congestion resending processing for, when it is determined that the state is a light congestion phase, resending a segment which has not been resent among segments requested to be resent while maintaining the window.

53. The congestion control method according to claim 39, wherein the apparatus of the sending side executes light congestion resending processing for, when it is determined that the state is a light congestion phase, resending a segment which has not been resent among segments requested to be resent while reducing the window by the amount corresponding to the segment size of the resent packet.

54. The congestion control method according to claim 39, wherein the apparatus of the sending side executes maximum transmittable sequence number correction processing for, when it is determined that the state is a light congestion phase, increasing the maximum value of a newly transmittable sequence number.

55. The congestion control method according to claim 39, wherein the apparatus of the sending side executes maximum transmittable sequence number correction processing for, when it is determined that the state is a light congestion phase, changing the maximum value of a newly transmittable sequence number to “the receiving-side largest received sequence number+congestion window size”.

56. The congestion control method according to claim 39, wherein the apparatus of the sending side executes normal transfer processing for, when the network is not in a congestion phase, sending a new packet while increasing the window and light congestion transfer processing for, when it is determined that there is not any unresent segment among segments requested to be resent, sending the new packet while increasing the window by an increase amount less than that of the normal transfer processing.

57. The congestion control method according to claim 39, wherein the apparatus of the sending side executes normal transfer processing for, when the network is not in a congestion phase, sending a new packet while increasing the window and light congestion transfer processing for, when it is determined that there is not any unresent segment among segments requested to be resent, maintaining the window for a predetermined time and then sending the new packet while increasing the window.

58. A program for a communication method used for a communication system using a window control in which, when a receiving side recognizes packet loss, the receiving side specifies the lost packet and requests a sending side to resend the packet, the program causing a computer for performing processing of the sending side to execute estimation processing for estimating the congestion state of a network based on information notified by the receiving side and one or more pieces of information about the congestion control state, processing for determining whether the state is a heavy congestion phase or not based on the congestion state estimated by the estimation means, and processing for, when it is determined that the state is not the heavy congestion phase, resending the lost packet while increasing a window for determining the transmission amount of the packet.
